(19) United States
(12) Patent Application Publication
(10) Pub. No.: US 2026/0061765 A1
(43) Pub. Date: Mar. 5, 2026

(54) MEDIUM CONVEYING APPARATUS AND RECORDING APPARATUS

(71) Applicant: SEIKO EPSON CORPORATION, Tokyo (JP)

(72) Inventors: Hiroyuki MAEDA, MATSUMOTO-SHI (JP); Hiroshi SHIOBARA, MATSUMOTO-SHI (JP); Shintaro KOMURO, MATSUMOTO-SHI (JP); Koji HARA, MATSUMOTO-SHI (JP); Koki MURAKAMI, AGEMATSU-MACHI (JP); Yuki HARA, SHIOJIRI-SHI (JP); Masato OGAWA, SHIOJIRI-SHI (JP); Masaki SHIMOMURA, MATSUMOTO-SHI (JP)

(21) Appl. No.: 19/308,511

(22) Filed: Aug. 25, 2025

(30) Foreign Application Priority Data
Aug. 28, 2024 (JP) 2024-146367

(51) Int. Cl. B41J 29/17; B41J 13/00; B41J 13/03; B41J 13/08

(52) U.S. Cl. CPC B41J 29/17; B41J 13/0027; B41J 13/03; B41J 13/08

(57) ABSTRACT

A medium conveying apparatus includes a conveyer configured to convey a medium, a cleaner configured to clean the conveyer, a scraper configured to come into contact with the cleaner to scrape off paper dust from the cleaner, and a receiver disposed below the scraper and configured to receive the paper dust, wherein the receiver is pulled out from an apparatus main body by being displaced in a first direction and is attached to the apparatus main body by being displaced in a second direction opposite to the first direction, and the scraper is provided to the receiver and comes into contact with the cleaner to scrape off the paper dust from the cleaner when the receiver is displaced in at least one of the first direction and the second direction.

The present application is based on, and claims priority from JP Application Serial Number 2024-146367, filed Aug. 28, 2024, the disclosure of which is hereby incorporated by reference herein in its entirety.

### BACKGROUND

### 1. Technical Field

The present disclosure relates to a medium conveying apparatus that conveys a medium, and a recording apparatus equipped with the medium conveying apparatus.

### 2. Related Art

The image forming apparatus described in JP-A-2014-227290 includes, in the vicinity of a pair of resist rollers, a paper dust collection member that comes into contact with a circumferential surface of one of the pair of resist rollers to collect paper dust. The paper dust collection member extends along an axial direction of the pair of resist rollers and is formed so as to be able to be pulled out along the axial direction.

A scraping member is disposed at a pull-out direction side of the paper dust collection member. When the paper dust collection member is pulled out in the axial direction, the paper dust adhering to the paper dust collection member is scraped off by the scraping member. A paper dust receiving recess is disposed, as a separate body from the paper dust collection member, below the scraping member, and the paper dust thus scraped out is received by the paper dust receiving recess. The paper dust accumulated in the paper dust receiving recess is discarded by an operator at the time of periodic inspection of the image forming apparatus.

JP-A-2014-227290 is an example of the related art.

The image forming apparatus described in JP-A-2014-227290 has a problem that it is difficult to discard the paper dust accumulated in the paper dust receiving recess.

### SUMMARY

A medium conveying apparatus according to the present disclosure for solving the problems described above includes a conveyer configured to convey a medium, a cleaner configured to clean the conveyer, a scraper configured to come into contact with the cleaner to scrape off paper dust from the cleaner, and a receiver disposed below the scraper and configured to receive the paper dust, wherein the receiver is pulled out from an apparatus main body by being displaced in a first direction and is attached to the apparatus main body by being displaced in a second direction opposite to the first direction, and the scraper is provided to the receiver and comes into contact with the cleaner to scrape off the paper dust from the cleaner when the receiver is displaced in at least one of the first direction and the second direction.

Further, a recording apparatus according to the present disclosure includes the medium conveying apparatus described above and a recording unit configured to perform recording on the medium.

### BRIEF DESCRIPTION OF THE DRAWINGS

FIG. 1 is a diagram illustrating a medium conveyance path of a printer.

FIG. 2 is a block diagram illustrating a control system of the printer.

FIG. 3 is a diagram of a belt unit, a blade, a scraper, and a receiver viewed from a medium width direction.

FIG. 4 is a diagram of the belt unit, the blade, the scraper, and the receiver viewed from a medium conveyance direction, and is a diagram showing a movement of the scraper when the receiver is pulled out.

FIG. 5 is a diagram of the belt unit, the blade, the scraper, and the receiver viewed from the medium width direction, and is a diagram illustrating a state in which the blade is displaced from a contact position to a separation position.

FIG. 6 is a diagram of the belt unit, the blade, the scraper, and the receiver viewed from the medium conveyance direction, and is a diagram showing the movement of the scraper and the displacement of the blade when the receiver is pull out.

FIG. 7 is a diagram of the belt unit, the blade, the scraper, and the receiver viewed from the medium conveyance direction.

FIG. 8 is a diagram of the belt unit, the blade, the scraper, and the receiver viewed from the medium conveyance direction.

### DESCRIPTION OF EMBODIMENTS

The present disclosure will schematically be described below.

A medium conveying apparatus according to a first aspect includes a conveyer configured to convey a medium, a cleaner configured to clean the conveyer, a scraper configured to come into contact with the cleaner to scrape off paper dust from the cleaner, and a receiver disposed below the scraper and configured to receive the paper dust, wherein the receiver is pulled out from an apparatus main body by being displaced in a first direction and is attached to the apparatus main body by being displaced in a second direction opposite to the first direction, and the scraper is provided to the receiver and comes into contact with the cleaner to scrape off the paper dust from the cleaner when the receiver is displaced in at least one of the first direction and the second direction.

According to the present aspect, since the receiver is pulled out from the apparatus main body by being displaced in the first direction and is attached to the apparatus main body by being displaced in the second direction, it becomes easy to discard the paper dust received by the receiver.

Further, the scraper is provided to the receiver, and comes into contact with the cleaner to scrape the paper dust from the cleaner when the receiver is displaced in at least one of the first direction and the second direction. Accordingly, it is not necessary to separately provide a mechanism for pulling out the receiver from and attaching the receiver to the apparatus main body and a mechanism for moving the scraper with respect to the cleaner, and it is possible to suppress an increase in cost and size of the apparatus.

A second aspect is an aspect according to the first aspect, wherein the scraper scrapes off the paper dust from the cleaner when the receiver is displaced in the first direction, and at least a part of the scraper is located at the second direction side with respect to the cleaner in a state where the receiver is attached to the apparatus main body.

According to the present aspect, the entire cleaner in the displacement direction of the receiver can be cleaned when the receiver is pulled out in the state in which the receiver is attached.

Note that the scraper scrapes off the paper dust from the cleaner when the receiver is displaced in the first direction, and may further scrape off the paper dust from the cleaner when the receiver is displaced in the second direction.

A third aspect is an aspect according to the first aspect, wherein the cleaner is displaceable between a contact position at which the cleaner is in contact with the conveyer and a separation position at which the cleaner is separated from the conveyer, and when the scraper scrapes off the paper dust from the cleaner, the cleaner is located at the separation position.

According to the present aspect, when the scraper scrapes off the paper dust from the cleaner, since the cleaner is located at the separation position, it becomes easy for the scraper to scrape the entire cleaner, specifically, the entire cleaner including a region in contact with the conveyer, and thus, the paper dust can efficiently be scraped off.

Note that the present aspect may be dependent from not only the first aspect described above but also the second aspect described above.

A fourth aspect is an aspect according to the third aspect, wherein when the scraper scrapes off the paper dust from the cleaner, the scraper scrapes the cleaner including a region in contact with the conveyer.

According to the present aspect, when the scraper scrapes off the paper dust from the cleaner, the scraper scrapes the cleaner including the region in contact with the conveyer, and thus the paper dust can efficiently be scraped off.

A fifth aspect is an aspect according to the third aspect, wherein the scraper scrapes off the paper dust from the cleaner when the receiver is displaced in the first direction, at least a part of the scraper is located at the second direction side with respect to the cleaner in a state where the receiver is attached to the apparatus main body, and the cleaner is displaced, before the scraper comes into contact with the cleaner, from the contact position to the separation position in conjunction with the displacement of the receiver in the first direction in the state where the receiver is attached to the apparatus main body.

According to the present aspect, since the scraper scrapes off the paper dust from the cleaner when the receiver is displaced in the first direction, and at least a part of the scraper is located at the second direction side with respect to the cleaner in the state where the receiver is attached to the apparatus main body, the entire cleaner in the displacement direction of the receiver can be cleaned when the receiver is pulled out in the state where the receiver is attached.

In addition, since the cleaner is displaced from the contact position to the separation position in conjunction with the displacement of the receiver, the operator does not need to individually operate the receiver and the cleaner, and the usability of the apparatus is improved.

Further, when the scraper starts scraping off the paper dust from the cleaner, since the cleaner is already displaced to the separation position as a result, the entire cleaner can be scraped over the entire scraping processing. In addition, the cleaner is not displaced while the scraper is scraping off the paper dust, and damage such as deformation can be prevented from occurring in the cleaner.

Note that the scraper scrapes off the paper dust from the cleaner when the receiver is displaced in the first direction, and may further scrape off the paper dust from the cleaner when the receiver is displaced in the first direction.

Note that the present aspect may be dependent from not only the third aspect described above but also the fourth aspect described above.

A sixth aspect is an aspect according to the third aspect, wherein the receiver is configured to engage with and disengage from a support member configured to support the cleaner, the cleaner is displaced from the separation position to the contact position by the receiver engaging with the support member, and the cleaner is displaced from e contact position to the separation position by the receiver disengaging from the support member.

According to the present aspect, since the receiver is displaced by engaging with or disengaging from the cleaner, a power source for displacing the cleaner is unnecessary, and an increase in cost of the apparatus can be suppressed.

Note that the present aspect may be dependent from not only the third aspect described above but also the fourth aspect or the fifth aspect described above.

A seventh aspect is an aspect according to the fourth aspect, wherein the cleaner is formed of a plate-shaped member, and the scraper is an elastic member having an acceptor configured to accept the plate-shaped member.

According to the present aspect, since the scraper is the elastic member having the acceptor configured to accept the plate-shaped member, it is easy to scrape off the paper dust from the plate-shaped member. In particular, it becomes easy to scrape off the paper dust from the entire plate-shaped member including the tip portion of the plate-shaped member.

Note that the present aspect may be dependent from not only the fourth aspect described above but also the fifth aspect or the sixth aspect described above.

An eighth aspect is an aspect according to the first aspect, wherein the scraper includes a brush.

According to the present aspect, since the scraper is formed of the brush, it becomes easy to scrape off the paper dust from the cleaner.

Note that the present aspect may be dependent from not only the first aspect described above but also any one of the second to sixth aspects described above.

In a ninth aspect, the scraper scrapes off the paper dust from the cleaner when the receiver is displaced in one of the first direction and the second direction, and the receiver includes a region configured to receive the paper dust at the first direction side and a region configured to receive the paper dust at the second direction side with respect to the scraper.

According to the present aspect, since the receiver has the region configured to receive the paper dust at the first direction side and the region configured to receive the paper dust at the second direction side with respect to the scraper, it is possible to prevent the paper dust from scattering to a position deviated from the receiver in the configuration in which the scraper scrapes off the paper dust when the receiver is displaced in one of the first direction and the second direction.

Note that the present aspect may be dependent from not only the first aspect described above but also any one of the second to eighth aspects described above.

A tenth aspect is an aspect according to the first aspect, and includes an opening-closing part configured to be opened and closed with respect to the apparatus main body, wherein the receiver moves in the first direction when the opening-closing part is opened and moves in the second direction when the opening-closing part is closed, in conjunction with opening and closing of the opening-closing part.

According to the present aspect, since the receiver moves in the first direction when the opening-closing part is opened and moves in the second direction when the opening-closing part is closed in conjunction with the opening and closing of the opening-closing part, the scraper can scrape off the paper dust from the cleaner in conjunction with the opening and closing of the opening-closing part, which does not require to separately operate the receiver, and improves the usability of the apparatus.

Note that the present aspect may be dependent from not only the first aspect described above but also any one of the second to ninth aspects described above.

An eleventh aspect is an aspect according to the tenth aspect, wherein the receiver is located at a position exposed by opening the opening-closing part.

According to the present aspect, since the receiver is located at a position exposed by opening the opening-closing part, it is possible to easily remove the paper dust accumulated in the receiver by opening the opening-closing part.

A twelfth aspect is an aspect according to the first aspect, and includes a controller configured to control the apparatus, and a notification unit configured to perform notification under control of the controller, wherein the controller causes the notification unit to announce pulling-out of the receiver from the apparatus main body when a number of media conveyed by the conveyer exceeds a threshold value.

According to the present aspect, when the number of media conveyed by the conveyer exceeds the threshold value, the controller causes the notification unit to announce pulling-out of the receiver from the apparatus main body, and thus it is possible to prevent the receiver from exceeding a storage capacity of the paper powder.

Note that the present aspect may be dependent from not only the first aspect described above but also any one of the second to eleventh aspects described above.

In a thirteenth aspect according to the first aspect, the conveyer conveys the medium with a conveyance belt.

According to the present aspect, in the configuration in which the conveyer conveys the medium with the conveyance belt, the functions and advantages of the first aspect described above can be obtained.

Note that the present aspect may be dependent from not only the first aspect described above but also any one of the second to twelfth aspects described above.

A recording apparatus according to a fourteenth aspect includes the medium conveying apparatus according to any one of the first to thirteenth aspects and a recording unit configured to perform recording on the medium.

According to the present aspect, in the recording apparatus, the functions and advantages of any one of the first to thirteenth aspects described above can be obtained.

The present disclosure will specifically be described below.

An inkjet printer 1 that performs recording by ejecting ink, which is an example of a liquid, onto a medium represented by recording paper will hereinafter be described as an example of a recording apparatus. The inkjet printer 1 is hereinafter abbreviated as a printer 1.

An X-Y-Z coordinate system illustrated in each drawing is an orthogonal coordinate system, and the Y-axis direction is a medium width direction crossing the conveyance direction of the medium, and is also an apparatus depth direction. In the present embodiment, out of the side surfaces forming a circumference of an apparatus main body 2, the side surface at the +Y direction side is a back surface, and the side surface at the −Y direction side is a front surface.

The X-axis direction is an apparatus width direction, and the +X direction side corresponds to the left side and the −X direction side corresponds to the right side when viewed from an operator of the printer 1. Further, the −X direction is a direction in which the medium is fed from each medium cassette described later.

The Z-axis direction is a vertical direction, that is, an apparatus height direction, the +Z direction is an upward direction, and the −Z direction is a downward direction.

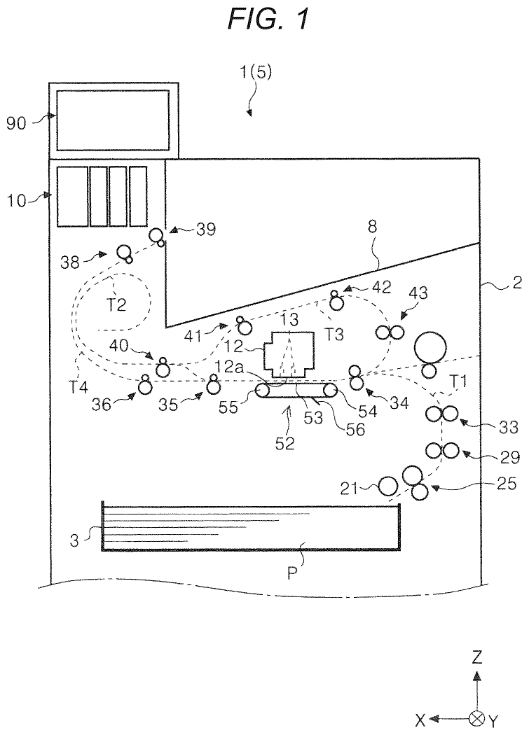

Hereinafter, a direction in which the medium is conveyed may be referred to as “downstream”, and the opposite direction may be referred to as “upstream” in some cases. In FIG. 1, a medium conveyance path is represented by a broken line. In the printer 1, the medium is conveyed through the medium conveyance path represented by the broken line.

Note that the printer 1 can also be referred to as a medium conveying apparatus 5 from the viewpoint of conveying the medium. In this case, the printer 1 is an example of a recording apparatus including the medium conveying apparatus 5 and a line head 12 described later.

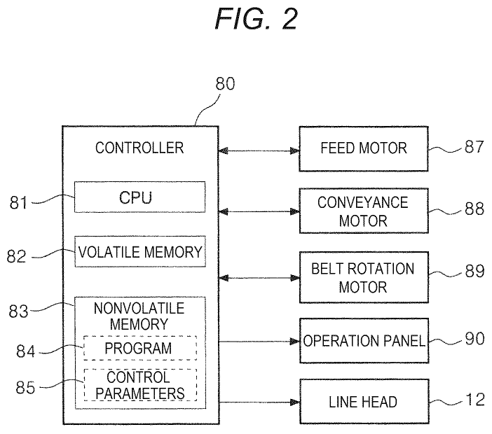

The printer 1 includes an operation panel 90 in an upper portion of the apparatus main body 2 including the line head 12 described later. The operation panel 90 is configured including a touch panel that receives various setting operations and displays various types of information. The operation panel 90 functions as a notification unit that performs various notifications under the control of a controller 80 (see FIG. 2) described later.

A medium cassette 3 is disposed in a lower portion of the apparatus main body 2. A reference symbol P denotes the medium housed in the medium cassette 3.

The medium cassette 3 is provided with a pickup roller 21 that feeds the medium housed therein toward the −X direction. In addition, the medium cassette 3 is provided with a feed roller pair 25 that feeds further downstream the medium fed by the pickup roller 21. Note that a plurality of medium cassettes (not shown) is further disposed below the medium cassette 3. A pick roller (not shown) and a feed roller pair (not shown) are provided for each of the plurality of medium cassettes (not shown).

Note that in the following description, it is assumed that the “roller pair” is configured with a drive roller which is driven by a power source such as a motor and a driven roller which is driven to rotate by being in contact with the drive roller unless otherwise described.

A reference symbol T1 represents a conveyance path of the medium which is fed from the medium cassette 3 and reaches a conveyance roller pair 34. Conveyance roller pairs 29, 33 apply feeding forth to the medium fed from the medium cassette 3 to feed the medium to the conveyance roller pair 34.

The medium to which the feeding forth is applied by the conveyance roller pair 34 is fed to a position between the line head 12, which is an example of a recording unit, and a conveyance belt 53, that is, to a recording position opposed to the line head 12.

The line head 12 performs recording by ejecting the ink, which is an example of the liquid, onto the medium from nozzles 13 provided to a nozzle surface 12a. In the present embodiment, an ejection direction of the ink from the nozzles 13 is the −Z direction. The line head 12 is an ink ejection head in which the plurality of nozzles 13 for ejecting the ink is disposed so as to cover the entire area in the medium width direction, and is configured as an ink ejection head capable of performing recording on the entire area in the medium width direction without moving in the medium width direction. However, the ink ejection head is not limited thereto, and may be a type that is mounted on a carriage and ejects the ink while moving in the medium width direction.

Further, the recording method is not limited to the inkjet method, and may be a dot impact method or an electrophotographic method such as a laser method or an LED method.

The line head 12 according to the present embodiment ejects the ink of a plurality of colors, as an example. Specifically, in the present embodiment, the plurality of nozzles 13 includes a plurality of nozzles 13 that ejects yellow ink, a plurality of nozzles 13 that ejects magenta ink, a plurality of nozzles 13 that ejects cyan ink, and a plurality of nozzles 13 that ejects black ink.

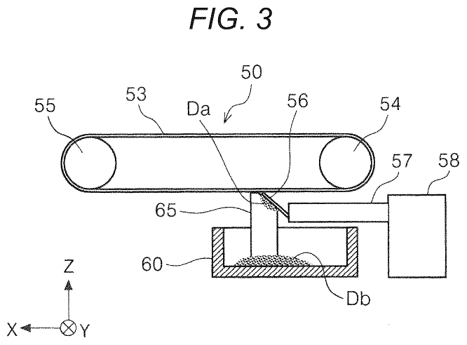

Then, the conveyance belt 53 is an endless belt wound around a first roller 54 which is the drive roller and a second roller 55 which is the driven roller, and is rotated by the first roller 54 being driven by a belt rotation motor 89 (see FIG. 3). The medium is conveyed through a position facing the line head 12 while being adsorbed to a belt surface of the conveyance belt 53. An electrostatic adsorption method can be adopted as the adsorption of the medium to the conveyance belt 53. However, an air suction method may be adopted as the adsorption of the medium to the conveyance belt 53.

The conveyance belt 53 constitutes a conveyer that conveys the medium.

The first roller 54, the second roller 55, and the conveyance belt 53 constitute a belt unit 52. The first roller 54 rotates with power applied from the belt rotation motor 89 (see FIG. 2), the conveyance belt 53 is rotated by the rotation of the first roller 54, and thus the medium is conveyed.

A reference numeral 56 denotes a blade as a cleaner that comes into contact with the conveyance belt 53 to remove paper dust adhering to the conveyance belt 53. The blade 56 is, for example, a plate-shaped member having a predetermined thickness, and is an elastically deformable elastic member, and is specifically formed of a PET sheet, and is elastically deformable in a state of being in contact with the conveyance belt 53. However, the blade 56 is not limited thereto, and may be formed of urethane, rubber, or the like.

In the present embodiment, the blade 56 is provided in an inclined posture such that the tip end thereof opposes the movement of the conveyance belt 53.

Note that not only paper dust but also foreign matter such as dust and ink may adhere to the conveyance belt 53 in some cases, and the blade 56 scrapes off such foreign matter and causes the foreign matter to fall below the conveyance belt 53. In the present specification, paper dust is treated as a representative example of foreign matter.

Note that a receiver 60 (see FIG. 3) described later is disposed below the blade 56, but is not illustrated in FIG. 1.

The medium having a first surface on which recording has been performed by the line head 12 is fed toward either a conveyance roller pair 36 or a conveyance roller pair 40 by the conveyance roller pair 35 located downstream of the conveyance belt 53. A path switching flap (not illustrated) is disposed downstream of the conveyance roller pair 35, and the medium to which the feeding force is applied by the conveyance roller pair 35 is fed to either the conveyance roller pair 36 or the conveyance roller pair 40 by the path switching flap.

When recording is not performed on both the first surface and a second surface opposite to the first surface of the medium, that is, when double-sided recording is not performed, the medium is fed from the conveyance roller pair 35 toward the conveyance roller pair 36, and is discharged toward a discharge tray 8 through a discharge path T4. A conveyance roller pair 38 and a conveyance roller pair 39 are disposed in the discharge path T4.

When recording is performed on both the first surface and the second surface opposite thereto of the medium, that is, when double-sided recording is performed, the medium is fed from the conveyance roller pair 35 toward the conveyance roller pair 40 and enters a switchback path T2. Subsequently, the rotational direction of the conveyance roller pair 40 is switched, the medium enters a flipping path T3, and is fed to the conveyance roller pair 34 by conveyance roller pairs 41, 42, and 43.

A reference numeral 10 denotes an ink container as a liquid container that stores the ink to be ejected. The ink to be ejected from the line head 12 is supplied from the ink container 10 to the line head 12 via a tube (not illustrated). The ink container 10 contains, for example, black ink, yellow ink, magenta ink, and cyan ink.

The overall configuration of the printer 1 has been described above, and the controller 80 that controls the printer 1 will hereinafter be described with reference to FIG. 2.

The controller 80 performs various types of control including recording control in the printer 1. Note that in FIG. 2, only components necessary for description in the present specification are illustrated, and other components are not illustrated.

As an output system, a feed motor 87, a conveyance motor 88, the belt rotation motor 89, the operation panel 90, and the line head 12 are electrically coupled to the controller 80.

The feed motor 87 is a power source of each of the pick rollers and each of the feed roller pairs described above. Further, the conveyance motor 88 is a power source of each of the conveyance roller pairs described above. The belt rotation motor 89 is a power source of the conveyance belt 53.

Each of the motors is, for example, a DC motor. Note that each of the motors described above is provided with a rotary encoder (not shown), and the controller 80 can detect a rotational direction, a rotation amount, and a rotation speed of each of the motors with the rotary encoder. That is, the controller 80 can detect a driving direction, a driving amount, and a driving speed of each driving target.

The controller 80 includes a CPU 81 that executes a computer program, in other words, software, a volatile memory 82, and a nonvolatile memory 83. The CPU 81 performs various calculations necessary for executing a program 84 stored in the nonvolatile memory 83. The volatile memory 82 is used as a temporary data storage area. The nonvolatile memory 83 stores the program 84 and control parameters 85 necessary for executing the program 84. The program 84 includes programs for executing various types of processing described later, and the control parameters 85 include parameters for executing the program 84. Various types of processing described later are realized by the controller 80 executing the program 84.

Further, the nonvolatile memory 83 stores print configuration information input of which is received via the operation panel 90.

Then, the receiver 60 and a scraper 65 disposed below the blade 56 will be described with reference to FIG. 3 and subsequent drawings. Note that the −Y direction is an example of a first direction in which the receiver 60 is pulled out, and the +Y direction is an example of a second direction in which the receiver 60 is attached.

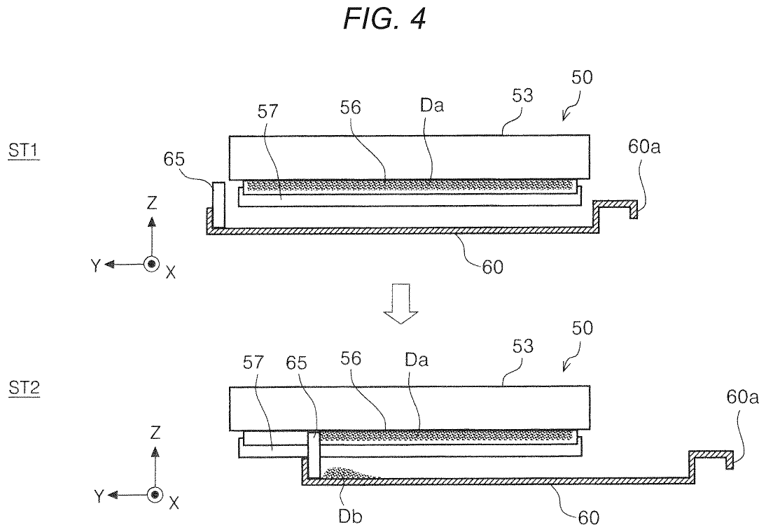

As illustrated in FIGS. 3 and 4, the receiver 60 that receives the paper dust is disposed below the blade 56. The receiver 60 is shaped like a tray and can house the paper dust inside. The receiver 60 is detachably attached to the apparatus main body 2.

A knob portion 60a is disposed in an end portion at the −Y direction side of the receiver 60, that is, at an apparatus front side, and the operator can remove the receiver 60 from the apparatus main body 2 by pinching the knob portion 60a to pull out the receiver 60 in the −Y direction. Further, the operator can attach the receiver 60 to the apparatus main body 2 by pinching the knob portion 60a to press the receiver 60 in the +Y direction.

Note that the receiver 60 is not limited to a configuration that can completely be removed from the apparatus main body 2, and may be a configuration that cannot be removed from the apparatus main body 2 as long as the paper dust stored therein can be collected by being pulled out from the apparatus main body 2.

The scraper 65 is provided to an end portion in the +Y direction of the receiver 60. The scraper 65 is a region that comes into contact with the blade 56 to scrape off paper dust from the blade 56, and is formed of, for example, an elastically deformable elastic material, and is further formed of a sponge as an example thereof.

Note that the scraper 65 may be formed of any other members, and can be formed of, for example, a brush.

A reference numeral 57 denotes a support member that supports the blade 56, and a reference numeral 58 denotes a base portion to which the support member 57 is fixed. In the present embodiment, both the support member 57 and the base portion 58 are fixedly provided to the apparatus main body 2, and therefore, the blade 56 is also fixedly provided.

The blade 56 is always in contact with the conveyance belt 53 in an inclined posture, and the scraped paper dust mainly adheres to the surface at the +X direction side of the blade 56. The scraper 65 is located at the +X direction side with respect to the blade 56 so that the paper dust can be scraped off from the blade 56.

Note that an upper end of the scraper 65 is not required to be in contact with the conveyance belt 53, but it is preferable that a certain gap is formed between the upper end of the scraper 65 and the conveyance belt 53 so that the scraped paper dust does not adhere to the conveyance belt 53.

In a state ST1 in FIG. 4, that is, in an attached state of the receiver 60, the scraper 65 is located at the +Y direction side with respect to the blade 56. In this state, when the receiver 60 is pulled out in the −Y direction as illustrated in a state ST2, the scraper 65 scrapes off the paper dust from the blade 56 due to the movement of the receiver 60. The paper dust thus scraped off is received by the receiver 60. In FIGS. 3 and 4, a reference symbol Da denotes what schematically shows the paper dust adhering to the blade 56, and a reference symbol Db denotes what schematically shows the paper dust received by the receiver 60.

Although not illustrated, when the receiver 60 is completely pulled out from the apparatus main body 2, the scraper 65 scrapes off the paper dust adhering to the blade 56 over the entire area in the Y-axis direction.

As described above, the receiver 60 is pulled out from the apparatus main body 2 by being displaced in the −Y direction, and is attached to the apparatus main body 2 by being displaced in the +Y direction. Further, the scraper 65 is provided to the receiver 60 and comes into contact with the blade 56 to scrape off the paper dust from the blade 56 when the receiver 60 is displaced in the −Y direction.

Therefore, by pulling out the receiver 60, it becomes easy to discard the paper dust received by the receiver 60.

Further, it is not necessary to separately provide a mechanism for pulling out the receiver 60 from and attaching the receiver 60 to the apparatus main body 2 and a mechanism for moving the scraper 65 with respect to the blade 56, and it is possible to suppress an increase in cost and size of the apparatus.

In addition, the operator does not need to separately perform two operations, that is, the movement of the receiver 60 and the movement of the scraper 65, and thus, the workability can be improved.

Note that in the present embodiment, the scraper 65 scrapes off the paper dust adhering to the blade 56 when the receiver 60 is pulled out, that is, when the receiver 60 is displaced in the −Y direction. However, when the paper dust remains on the blade 56, the scraper 65 can also scrape off the paper dust adhering to the blade 56 when attaching the receiver 60, that is, when the receiver 60 is displaced in the +Y direction.

Further, in the present embodiment, the scraper 65 scrapes off the paper dust from the blade 56 when the receiver 60 is displaced in the −Y direction, and the scraper 65 is located at the +Y direction side with respect to the blade 56 in a state where the receiver 60 is attached to the apparatus main body 2 as illustrated in the state ST1 in FIG. 4.

Due to such a configuration, when the receiver 60 is pulled out in the state in which the receiver 60 is attached, the entire blade 56 in the displacement direction of the receiver 60 can be cleaned.

Note that in the present embodiment, the entire scraper 65 is located at the +Y direction side with respect to the blade 56 in the attached state of the receiver 60, but this is not a limitation, and only a part of the scraper 65 may be located at the +Y direction side with respect to the blade 56.

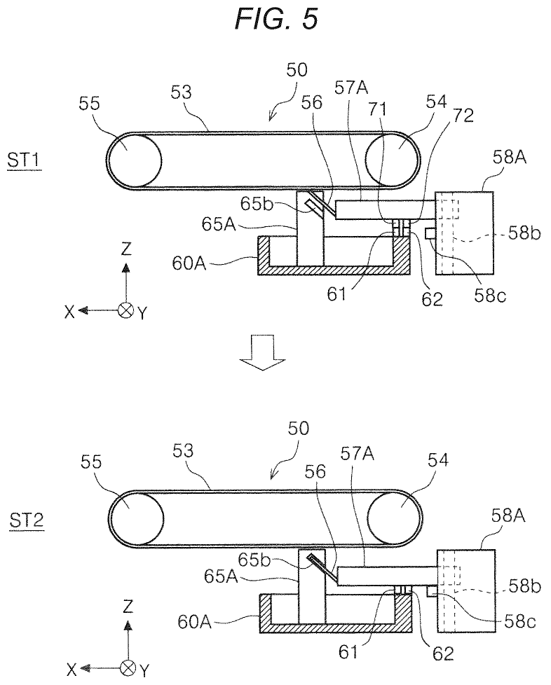

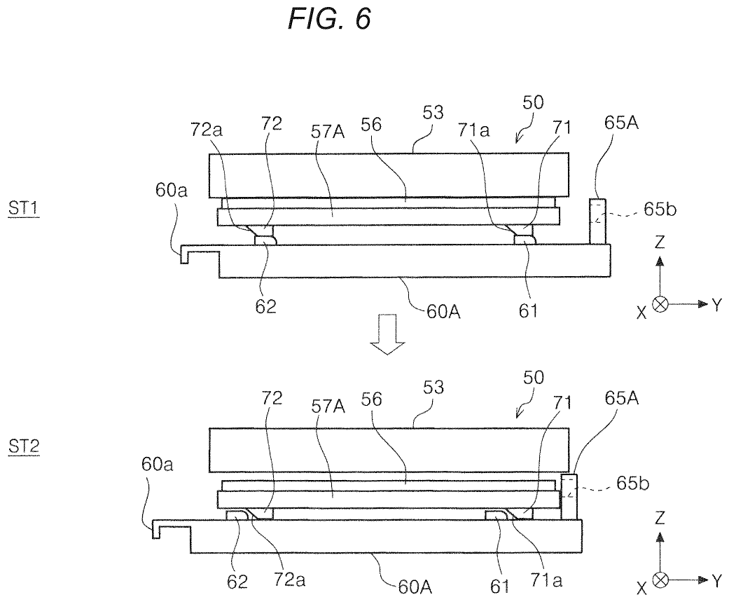

Then, another embodiment will be described with reference to FIGS. 5 and 6. Note that in the embodiment described below, the same components s as those in the embodiment having already been described above are denoted by the same reference numerals, and redundant description will be avoided. In addition, the configurations obtained by modifying the configurations having already been described above are distinguished by adding upper case letters to the numbers. Further, in FIG. 6, for the sake of convenience of illustration, each configuration is viewed from the −X direction unlike FIG. 4.

In the embodiment shown in FIGS. 5 and 6, the blade 56 is displaceable in an up-down direction.

More specifically, the blade 56 is supported by a support member 57A. The support member 57A is held by a guide portion 58b provided to a base portion 58A so as to be displaceable in the Z-axis direction. Note that a stopper 58c is provided to the base portion 58A, and a displacement limit of the support member 57A in the −Z direction is defined by the stopper 58c.

A first cam follower portion 71 and a second cam follower portion 72 are disposed below the support member 57A. As illustrated in FIG. 6, the second cam follower portion 72 is disposed at an interval in the −Y direction with respect to the first cam follower portion 71. The first cam follower portion 71 is provided with an inclined surface 71a at the −Y direction side, and the second cam follower portion 72 is provided with an inclined surface 72a at the −Y direction side.

In addition, the first cam follower portion 71 and the second cam follower portion 72 are disposed such that the positions thereof in the X-axis direction are shifted from each other as illustrated in FIG. 5.

A first cam portion 61 and a second cam portion 62 are disposed above a receiver 60A at the −X direction side. As illustrated in FIG. 6, the second cam portion 62 is disposed at an interval in the −Y direction with respect to the first cam portion 61.

In addition, as illustrated in FIG. 5, the first cam portion 61 and the second cam portion 62 are disposed so that the positions thereof in the X-axis direction are shifted from each other. Further, the first cam portion 61 is disposed at a position where the first cam portion 61 can engage with the first cam follower portion 71 in the X-axis direction, and further, the second cam portion 62 is disposed at a position where the second cam portion 62 can engage with the second cam follower portion 72 in the X-axis direction.

The state ST1 in FIG. 5 and the state ST1 in FIG. 6 correspond to a state in which the receiver 60A is attached to the apparatus main body 2. In this state, the first cam follower portion 71 rides on the first cam portion 61, and the second cam follower portion 72 rides on the second cam portion 62. This state is a state in which the support member 57A and the blade 56 are pushed up the furthest in the +Z direction, and thus, the blade 56 comes into contact with the conveyance belt 53 to be able to remove the paper dust adhering to the conveyance belt 53.

In this state, when the receiver 60A is pulled out in the −Y direction, the first cam portion 61 is separated from the first cam follower portion 71, and the second cam portion 62 is separated from the second cam follower portion 72 as illustrated in the state ST2 in FIG. 5 and the state ST2 in FIG. 6. Accordingly, the support member 57A and the blade 56 are displaced toward the −Z direction, and the blade 56 is separated from the conveyance belt 53.

In this state, a scraper 65A is located at the +Y direction side with respect to the blade 56, and the scraper 65A scrapes off the paper dust from the blade 56 as the receiver 60A is further pulled out in the −Y direction.

Note that in the present embodiment, in the state ST1 in FIG. 5 and the state ST1 in FIG. 6, that is, in the attached state of the receiver 60A, only the self-weights of the support member 57A and the blade 56 act between the first cam portion 61 and the first cam follower portion 71 and between the second cam portion 62 and the second cam follower portion 72. However, a pressing member such as a spring that presses the support member 57A in the −Y direction may be separately provided.

Then, the scraper 65A according to the present embodiment is provided with an acceptor 65b. The acceptor 65b is disposed at a position and has a size so as to be capable of receiving the blade 56 that is separated from the conveyance belt 53. However, an inner surface of the acceptor 65b is formed so as to be able to come into contact with particularly a surface at the +X direction side of the blade 56 so as to be able to scrape off the paper dust adhering to the blade 56 thus accepted. Further, in the present embodiment, the inner surface of the acceptor 65b can also come into contact with a surface at the −X direction side of the blade 56.

As described above, since the scraper 65A is an elastic member having the acceptor 65b that accepts the blade 56, it is easy to scrape off the paper dust from the blade 56. In particular, it is easy to scrape off the paper dust from the entire blade 56 including the tip portion of the blade 56.

As described above, in the present embodiment, the blade 56 can be displaced between the contact position where the blade 56 is in contact with the conveyance belt 53 and the separation position where the blade 56 is separated from the conveyance belt 53. Further, when the scraper 65A scrapes off the paper dust from the blade 56, the blade 56: is located at the separation position. Accordingly, the scraper 65A easily scrapes the entire blade 56, specifically, the entire blade 56 including the tip portion to be in contact with the conveyance belt 53, and can efficiently scrape off the paper dust.

Further, when the scraper 65A scrapes off the paper dust from the blade 56, the scraper 65A scrapes the blade 56 including a region to be in contact with the conveyance belt 53, specifically, the tip portion. Accordingly, the paper dust can efficiently be scraped off.

Further, in the present embodiment, the scraper 65A scrapes off the paper dust from the blade 56 when the receiver 60A is displaced in the −Y direction. The scraper 65A is located at the +Y direction side with respect to the blade 56 in a state where the receiver 60A is attached to the apparatus main body 2. Before the scraper 65A comes into contact with the blade 56, the blade 56 is displaced from the contact position to the separation position in conjunction with the displacement in the −Y direction of the receiver 60A in the state of being attached to the apparatus main body 2.

This makes it possible to clean the entire blade 56 in the displacement direction of the receiver 60A when the receiver 60A is pulled out in the state in which the receiver 60A is attached.

Further, since the blade 56 is displaced from the contact position to the separation position in conjunction with the displacement of the receiver 60A, the operator does not need to individually operate the receiver 60A and the blade 56, which improves the usability of the apparatus.

In addition, since the blade 56 is already displaced to the separation position when the scraper 65A starts scraping off the paper dust from the blade 56, the entire blade 56 can be scraped over the entire scraping processing. In addition, the blade 56 is not displaced while the scraper 65A is scraping off the paper dust, which can prevent damage such as deformation from occurring in the blade 56.

Note that the scraper 65A scrapes off the paper dust from the blade 56 when the receiver 60A is pulled out, that is, when the receiver 60A is displaced in the −Y direction, but may further scrape off the paper dust from the blade 56 when the receiver 60A is attached, that is, when the receiver 60A is displaced in the +Y direction.

Note that after the scraper 65A is separated from the blade 56, the blade 56 is displaced from the separation position to the contact position in conjunction with the displacement of the receiver 60A in the +Y direction in the state of being pulled out from the apparatus main body 2. That is, the blade 56 is not displaced from the separation position to the contact position in the state where the scraper 65A is in contact with the blade 56. Accordingly, deformation and breakage of the blade 56 can be suppressed.

Note that the inclined surface 71a of the first cam follower portion 71 prevents the first cam portion 61 from being caught by the first cam follower portion 71 when attaching the receiver 60A. Similarly, the inclined surface 72a of the second cam follower portion 72 prevents the second cam portion 62 from being caught by the second cam follower portion 72 when attaching the receiver 60A. Accordingly, the blade 56 can be smoothly and reliably displaced from the separation position to the contact position.

Further, in the present embodiment, the receiver 60A can engage with and disengage from the support member 57A that supports the blade 56. The blade 56 is displaced from the separation position to the contact position when the receiver 60A engages with the support member 57A. Further, when the receiver 60A disengages from the support member 57A, the blade 56 is displaced from the contact position to the separation position.

Due to such a configuration, a power source for displacing the blade 56 becomes unnecessary, and an increase in cost of the apparatus can be suppressed.

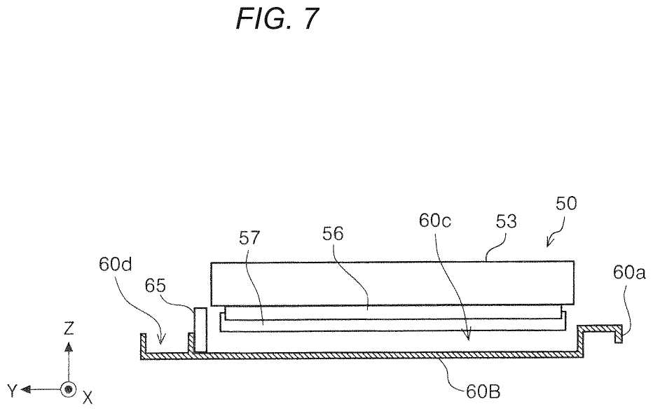

Then, still another embodiment will be described with reference to FIG. 7.

The scraper 65 scrapes off the paper dust from the blade 56 when the receiver 60B is displaced in the −Y direction or the +Y direction. In such a configuration, a receiver 60B includes a first container 60c that is a region that receives the paper dust at the −Y direction side with respect to the scraper 65, and a second container 60d that is a region that receives the paper dust at the +Y direction side.

Accordingly, when the receiver 60B is displaced in the −Y direction or the +Y direction, it is possible to prevent the paper dust from scattering to a position deviated from the receiver 60B.

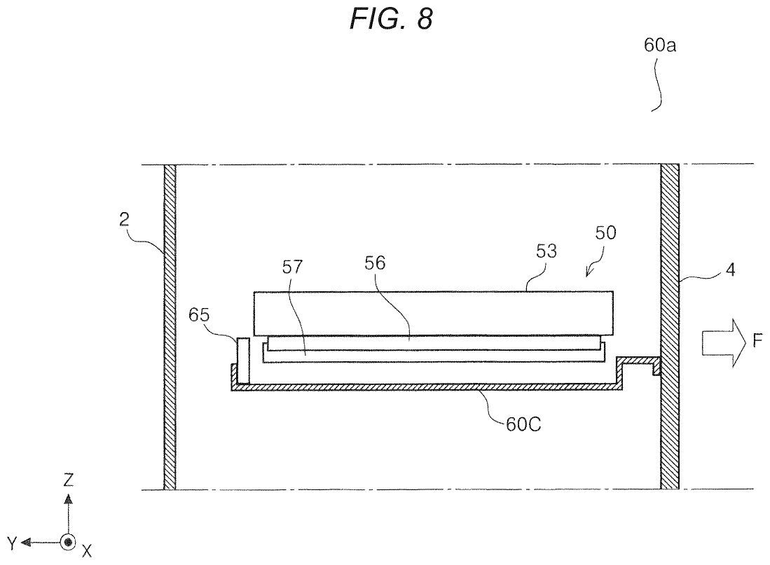

Then, still another embodiment will be described with reference to FIG. 8.

The apparatus main body 2 includes an opening-closing part 4 that can be opened and closed with respect to the apparatus main body 2. FIG. 8 shows a state where the opening-closing part 4 is closed, and the opening-closing part 4 can be opened toward a direction of the arrow F. When the opening-closing part 4 is opened, the inside of the apparatus main body 2 is exposed.

A receiver 60C is coupled to the opening-closing part 4. Further, the receiver 60C moves in the −Y direction when the opening-closing part 4 is opened, and moves in the +Y direction when the opening-closing part 4 is closed in conjunction with the opening-closing operation of the opening-closing part 4. According to such a configuration, the scraper 65 can scrape off the paper dust from the blade 56 in conjunction with the opening-closing operation of the opening-closing part 4, which does not require to separately operate the receiver 60C, and improves the usability of the apparatus.

Note that although the opening-closing part 4 may open and close any region of the apparatus main body 2, it is preferable that the receiver 60C is located at a position exposed by opening the opening-closing part 4 as in the present embodiment. Accordingly, the paper dust accumulated in the receiver 60C can easily be removed by opening the opening-closing part 4.

Note that in each of the embodiments described above, the controller 80 may count the number of media conveyed by the conveyance belt 53, and when the count value exceeds a threshold value, the controller 80 may cause the operation panel 90 to announce pulling-out of the receiver 60 from the apparatus main body 2. As a result, it is possible to prevent the receiver 60 from exceeding the paper dust storage capacity.

In addition, a sensor (not illustrated) that detects an amount such as an accumulation height of the paper dust in the receiver 60 may be provided. Then, when the accumulation height of the paper dust reaches a predetermined value, the controller 80 may cause the operation panel 90 to announce pulling-out of the receiver 60 from the apparatus main body 2.

The present disclosure is not limited to the embodiments and modifications described above, but various modifications can be made within the scope of the disclosure set forth in the appended claims, and it is obvious that these modifications also fall within the scope of the present disclosure.

What is claimed is:

1. A medium conveying apparatus comprising:
a conveyer configured to convey a medium;
a cleaner configured to clean the conveyer;
a scraper configured to come into contact with the cleaner to scrape off paper dust from the cleaner; and
a receiver disposed below the scraper and configured to receive the paper dust, wherein
the receiver is pulled out from an apparatus main body by being displaced in a first direction and is attached to the apparatus main body by being displaced in a second direction opposite to the first direction, and
the scraper is provided to the receiver and comes into contact with the cleaner to scrape off the paper dust from the cleaner when the receiver is displaced in at least one of the first direction and the second direction.

2. The medium conveying apparatus according to claim 1, wherein
the scraper scrapes off the paper dust from the cleaner when the receiver is displaced in the first direction, and
at least a part of the scraper is located at the second direction side with respect to the cleaner in a state where the receiver is attached to the apparatus main body.

3. The medium conveying apparatus according to claim 1, wherein
the cleaner is displaceable between a contact position at which the cleaner is in contact with the conveyer and a separation position at which the cleaner is separated from the conveyer, and
when the scraper scrapes off the paper dust from the cleaner, the cleaner is located at the separation position.

4. The medium conveying apparatus according to claim 3, wherein
when the scraper scrapes off the paper dust from the cleaner, the scraper scrapes the cleaner including a region in contact with the conveyer.

5. The medium conveying apparatus according to claim 3, wherein
the scraper scrapes off the paper dust from the cleaner when the receiver is displaced in the first direction,
at least a part of the scraper is located at the second direction side with respect to the cleaner in a state where the receiver is attached to the apparatus main body, and
the cleaner is displaced, before the scraper comes into contact with the cleaner, from the contact position to the separation position in conjunction with the displacement of the receiver in the first direction in the state where the receiver is attached to the apparatus main body.

6. The medium conveying apparatus according to claim 3, wherein
the receiver is configured to engage with and disengage from a support member configured to support the cleaner,
the cleaner is displaced from the separation position to the contact position by the receiver engaging with the support member, and
the cleaner is displaced from the contact position to the separation position by the receiver disengaging from the support member.

7. The medium conveying apparatus according to claim 4, wherein
the cleaner is formed of a plate-shaped member, and
the scraper is an elastic member having an acceptor configured to accept the plate-shaped member.

8. The medium conveying apparatus according to claim 1, wherein
the scraper includes a brush.

9. The medium conveying apparatus according to claim 1, wherein
the scraper scrapes off the paper dust from the cleaner when the receiver is displaced in one of the first direction and the second direction, and
the receiver includes a region configured to receive the paper dust at the first direction side and a region configured to receive the paper dust at the second direction side with respect to the scraper.

10. The medium conveying apparatus according to claim 1, further comprising
an opening-closing part configured to be opened and closed with respect to the apparatus main body, wherein
the receiver moves in the first direction when the opening-closing part is opened and moves in the second direction when the opening-closing part is closed, in conjunction with opening and closing of the opening-closing part.

11. The medium conveying apparatus according to claim 10, wherein
the receiver is located at a position exposed by opening the opening-closing part.

12. The medium conveying apparatus according to claim 1, further comprising:
a controller configured to control the apparatus; and
a notification unit configured to perform notification under control of the controller, wherein
the controller causes the notification unit to announce pulling-out of the receiver from the apparatus main body when a number of media conveyed by the conveyer exceeds a threshold value.

13. The medium conveying apparatus according to claim 1, wherein
the conveyer conveys the medium with a conveyance belt.

14. A recording apparatus comprising:
the medium conveying apparatus according to claim 1; and
a recording unit configured to perform recording on the medium.
